(19) United States
(12) Patent Application Publication
(10) Pub. No.: US 2012/0249903 A1
(43) Pub. Date: Oct. 4, 2012

(54) LIQUID CRYSTAL DISPLAY APPARATUS AND METHOD FOR DRIVING THE SAME

(75) Inventor: Hirokazu ARITAKE, Atsugi (JP)

(73) Assignee: FUJITSU LIMITED, Kawasaki-shi (JP)

(21) Appl. No.: 13/426,986

(22) Filed: Mar. 22, 2012

(30) Foreign Application Priority Data
Mar. 31, 2011 (JP) 2011-077066

(51) Int. Cl. G02F 1/1343; G02F 1/133

(52) U.S. Cl. 349/34

(57) ABSTRACT

A controlling method of a display apparatus that includes a display device including a plurality of pixels, each of the pixels being formed of a cholesteric liquid crystal material, the controlling method includes: applying the first voltage making the cholesteric liquid crystal material transparent between the first and the second electrodes; applying the second voltage setting reflectance of the cholesteric liquid crystal material in each of the pixels at the time of selection of the each of the pixels between the first and the second electrodes; and applying the third voltage providing no change in reflectance of the cholesteric liquid crystal material between the first and the second electrodes.

### CROSS-REFERENCE TO RELATED APPLICATIONS

This application is based upon and claims the benefit of priority from the prior Japanese Patent Application No. 2011-077066, filed on Mar. 31, 2011, the entire contents of which are incorporated herein by reference.

### FIELD

The embodiments disclosed hereafter are related to a method for driving a liquid crystal display screen using a cholesteric liquid crystal layer, and are related to a display apparatus.

### BACKGROUND

The reflectance of a cholesteric liquid crystal material depends on an applied voltage before the voltage is sharply reduced. After the applied voltage is reduced and then shut off to a zero voltage (hereinafter referred to as ground voltage), the reflectance does not change but is maintained.

Based on the characteristic of a cholesteric liquid crystal material, a display apparatus including a display section using a cholesteric liquid crystal material has been developed in recent years.

Such a display apparatus including a display section using a cholesteric liquid crystal material, which may display a predetermined image without voltage application as described above, is expected to be used as electronic paper that may replace paper of related art. Since electronic paper, however, still requests electric power when it rewrites displayed information on the screen, a battery or another electric power source is typically provided. It is therefore desirable to reduce power consumption.

An example of a process that consumes relatively high electric power is moving a cursor over a predetermined image displayed on a screen. In the process, for example, the cursor is displayed on display pixels on which an image has already been displayed, and the cursor is then moved to another position. Consider now the operation of the display pixels. First, voltage application and shut off are performed on the display pixels in order to display the cursor.

Thereafter, voltage application and shut off are performed again on the display pixels in order to restore the displayed information before the cursor was moved.

Japanese Laid-Open Patent Publication No. 11-326871 is exemplified as a related art document.

### SUMMARY

According to one aspect of the embodiments, there is provided a display apparatus includes: a display device configured to include a plurality of pixels, each of the pixels being formed of a cholesteric liquid crystal material; a first electrode and a second electrode that apply a voltage to each of the pixels; and a drive circuit configured to apply a first voltage, a second voltage, and third voltage between the first and the second electrodes, applying the first voltage making the cholesteric liquid crystal material transparent, applying the second voltage setting reflectance of the cholesteric liquid crystal material in each of the pixels at the time of selection of the each of the pixels, applying the third voltage providing no change in reflectance of the cholesteric liquid crystal material.

According to another aspect of the embodiments, there is provided a controlling method of a display apparatus that includes a display device including a plurality of pixels, each of the pixels being formed of a cholesteric liquid crystal material, the controlling method includes: applying the first voltage making the cholesteric liquid crystal material transparent between the first and the second electrodes; applying the second voltage setting reflectance of the cholesteric liquid crystal material in each of the pixels at the time of selection of the each of the pixels between the first and the second electrodes; and applying the third voltage providing no change in reflectance of the cholesteric liquid crystal material between the first and the second electrodes.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF THE DRAWINGS

FIG. 1 is a block diagram depicting a display apparatus according to a first embodiment;

FIG. 2 depicts a cross-sectional structure of a cholesteric liquid crystal display device accommodated in the display apparatus according to the first embodiment;

FIG. 3 depicts an example of a voltage-reflectance characteristic of a cholesteric liquid crystal layer according to the present embodiment;

FIG. 4A describes how to maintain a focal conic state of a cholesteric liquid crystal layer, and FIG. 4B describes the focal conic state;

FIG. 5A describes how to maintain a planar state of the cholesteric liquid crystal layer, and FIG. 5B describes the planar state;

FIG. 6 describes a coordinate extraction mode in the display apparatus including the cholesteric liquid crystal display device according to the first embodiment;

FIG. 7 depicts voltage application to X electrode lines and Y electrode lines in a vertical line moving step;

FIG. 8A are waveform diagrams depicting a voltage application sequence for moving a vertical black line or a horizontal black line;

FIG. 8B are waveform diagrams depicting another voltage application sequence for moving a vertical black line or a horizontal black line;

FIG. 9 describes a coordinate extraction mode according to a second embodiment in the display apparatus including the cholesteric liquid crystal display device;

FIG. 10 depicts voltage application to the X electrode lines and the Y electrode lines in a vertical line/horizontal line moving step; and

FIG. 11 is waveform diagrams depicting a black line moving voltage application sequence for moving a vertical black line between arbitrary adjacent X electrode lines, a first X electrode line and a second X electrode line, and moving a horizontal black line between arbitrary adjacent Y electrode lines, a first Y electrode line and a second Y electrode line, in the cholesteric liquid crystal display device.

### DESCRIPTION OF THE EMBODIMENTS

Modes for carrying out the present invention will be described below with reference to embodiments.

### First Embodiment

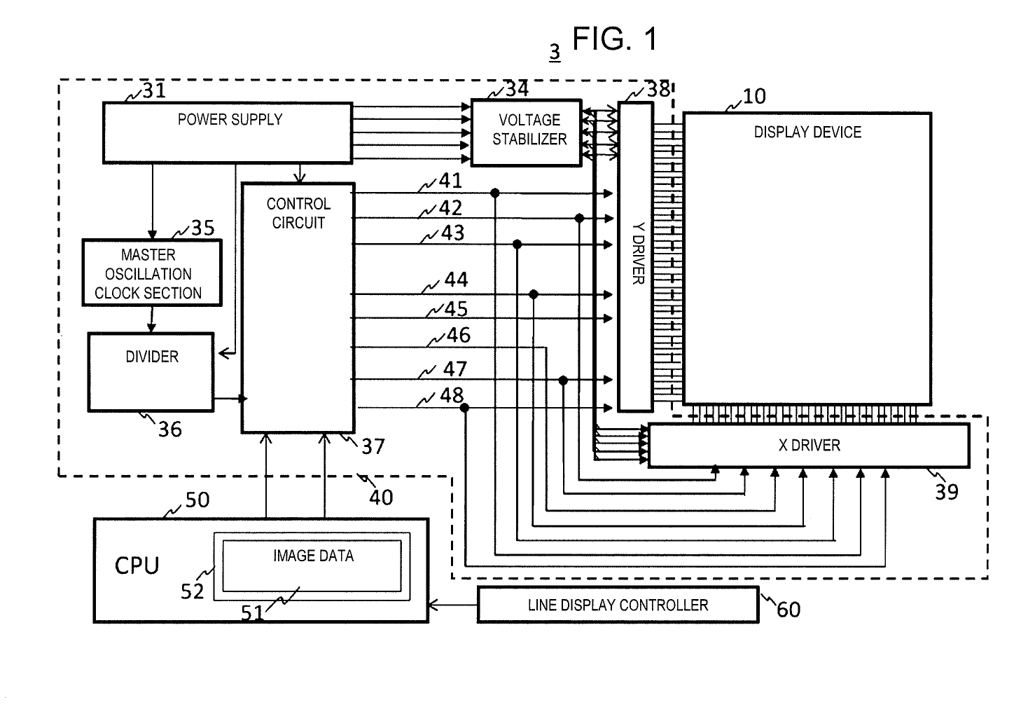

FIG. 1 is a block diagram depicting a display apparatus 30 according to a first embodiment. The display apparatus 30 according to the first embodiment includes a cholesteric liquid crystal display device 10, a drive circuit 40, a CPU 50, and a line display controller 60.

The cholesteric liquid crystal display device 10 is based on a display device including a blue cholesteric liquid crystal layer, a display device including a green cholesteric liquid crystal layer, and a display device including a red cholesteric liquid crystal layer.

The drive circuit 40 includes a power supply 31, a voltage stabilizer 34, a master oscillation clock section 35, a divider 36, a control circuit 37, a Y driver 38, and an X driver 39. The drive circuit 40 receives a variety of control signals that the CPU 50 outputs based on image data 51 and data outputted from the line display controller 60 and instructs the cholesteric liquid crystal display device 10 to display an image. The image data 51 represents an image that a user desires to display on the cholesteric liquid crystal display device 10.

The X driver 39 applies voltages to a plurality of X electrode lines. The Y driver 38 applies voltages to a plurality of Y electrode lines.

The power supply 31 is a power supply circuit that outputs voltages ranging, for example, from 0 to 40 V. The voltage stabilizer 34 is, for example, a voltage follower circuit formed of an operation amplifier and stabilizes the voltages supplied from the power supply 31.

The master oscillation clock section 35 is a clock generation circuit that generates a base clock based on which the display apparatus 30 operates. The divider 36 is a clock distribution circuit that divides the base clock to generate a variety of clocks that are requested for the operation of the display apparatus 30.

The control circuit 37 operates upon reception of the variety of clocks from the divider 36 and the variety of control signals from the CPU 50 and produces display data 48. The control circuit 37 then supplies the display data 48 to the Y driver 38 and the X driver 39. The control signals include electrode line selection data 41, a data acquisition clock CLK 42, a black line display signal FST 43, a pulse polarity control signal FR 44, a Y electrode line data latch signal 45, an X electrode line data latch signal 46, and a driver output turn-off signal 47.

The electrode line selection data 41 specifies a Y electrode line and an X electrode line used to display a black line.

The data acquisition clock CLK 42 is used to transfer the electrode line selection data 41 and the display data 48 in the Y driver 38 and the X driver 39.

The black line display signal FST 43 instructs to start displaying a black line, and the Y driver 38 and the X driver 39 display a black line in response to the black line display signal FST 43.

The pulse polarity control signal FR 44 reverses the polarity of an applied voltage, and the X driver 39 and the Y driver 38 reverse the polarities of outputted signals in accordance with the pulse polarity control signal FR 44.

The X electrode line data latch signal 45 instructs to stop transferring the electrode line selection data 41 in the Y driver 38, and the Y driver 38 latches the transferred electrode line selection data 41 in response to the signal.

The Y electrode line data latch signal 46 instructs to stop transferring the electrode line selection data 41 in the X driver 39, and the X driver 39 latches the transferred electrode line selection data 41 in response to the signal.

The driver output turn-off signal 47 forcibly turns off applied voltages. The display data 48 is sent to the Y driver 38 and the X driver 39 to allow them to display an image having brightness (grayscale) values on the cholesteric liquid crystal display device 10 and contains brightness (grayscale) codes. The Y driver 38 and the X driver 39, upon reception of the brightness (grayscale) codes, which represent the brightness (grayscale) of pixels, supply voltages corresponding to the pixel brightness (grayscale) values to the electrode lines, as will be described later.

The CPU 50 includes a storage device 52 that holds the image data 51. The CPU 50 receives the image data 51 and instruction signals from the line display controller and outputs control signals to the drive circuit 40. The control circuit 37 displays an image on the display device in response to the control signals from the CPU 50. The CPU 50 produces the display data 48 based on the image data 51.

The line display controller 60 outputs a plurality of instruction signals to the CPU 50. The plurality of instruction signals form instruction codes. The line display controller 60 has a four-arrow key, an enter button, and other components attached to the line display controller 60. When the user operates the four-arrow key, the enter button, or any other component in a certain way, the line display controller 60 outputs a plurality of instruction signals that instruct to switch an operation mode between a position detection mode and an image display mode. In the position detection mode, the cholesteric liquid crystal display device 10 displays a black line. When the user operates the four-arrow key, the enter button, or any other component in another way, the line display controller 60 outputs a plurality of instruction signals that instruct to move the black line. That is, the line display controller 60 instructs the display apparatus 30 to switch its operation mode between the position detection mode and the image display mode.

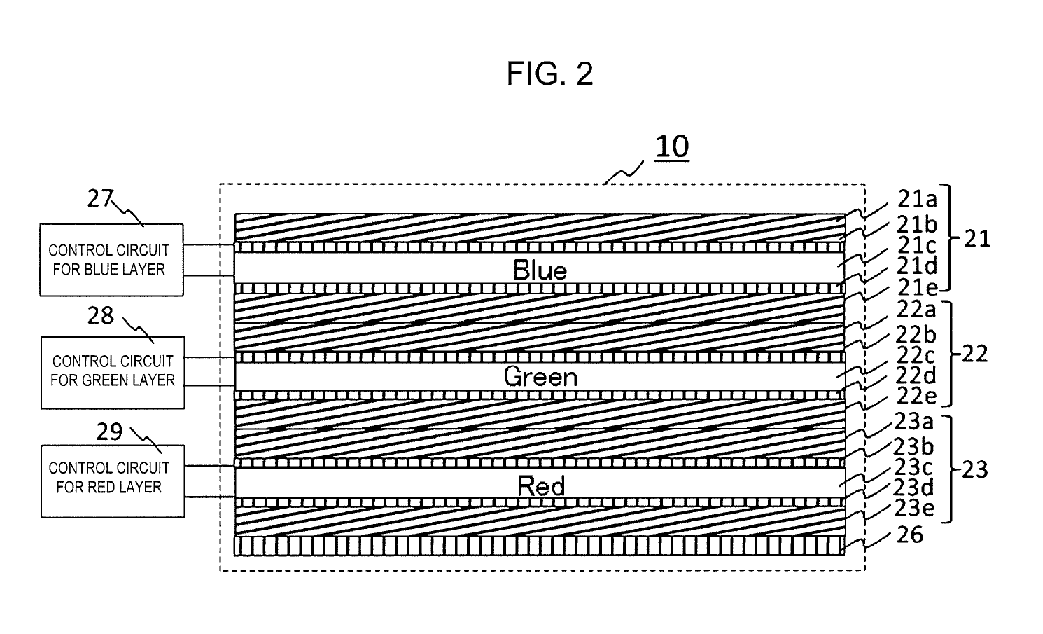

FIG. 2 depicts a cross-sectional structure of the cholesteric liquid crystal display device 10 accommodated in the display apparatus 30 according to the first embodiment. The cholesteric liquid crystal display device 10 includes a liquid crystal display device 21 that displays a blue image, a liquid crystal display device 22 that displays a green image, a liquid crystal display device 23 that displays a red image, and a light absorbing layer 26. The liquid crystal display device 21 includes a lower transparent substrate 21e, a lower electrode layer 21d, a cholesteric liquid crystal layer 21c, an upper electrode layer 21b, and an upper transparent substrate 21a. The liquid crystal display device 22 includes a lower transparent substrate 22e, a lower electrode layer 22d, a cholesteric liquid crystal layer 22c, an upper electrode layer 22b, and an upper transparent substrate 22a.

The liquid crystal display device 23 includes a lower transparent substrate 23e, a lower electrode layer 23d, a cholesteric liquid crystal layer 23c, an upper electrode layer 23b, and an upper transparent substrate 23a.

Drive circuits 27, 28, and 29 drive the liquid crystal display devices 21, 22, and 23, respectively. Each of the drive circuits 27, 28, and 29 is similar to the drive circuit 40 depicted in FIG. 1, and no description thereof will therefore be made.

Each of the upper transparent substrates 21a, 22a, and 23a and the lower transparent substrates 21e, 22e, and 23e is a light-transmissive glass substrate. Each of the substrates, which are made of glass in the above description, may not necessarily be a glass substrate but may be a light-transmissive film substrate made, for example, of PET (polyethylene terephthalate) or PC (polycarbonate). Spacers may be provided between the upper transparent substrates 21a, 22a, 23a and the lower transparent substrates 21e, 22e, 23e in order to maintain a uniform gap therebetween. Each of the spacers is preferably a fixed spacer made, for example, of a resin or an inorganic oxide or a fixed spacer on which a thermoplastic resin is coated. Each of the spacers has, for example, a spherical shape, and the gap formed by the spacers between the upper transparent substrates 21a, 22a, 23a and the lower transparent substrates 21e, 22e, 23e desirably ranges from 4 to 6 μm. When the gap described above is 4 μm or smaller, the reflectance of a cholesteric liquid crystal layer 17 decreases. In this case, an image displayed on the cholesteric liquid crystal display device 10 becomes darker, and no high display threshold steepness is expected. On the other hand, when the gap described above is 6 μm or greater, a drive voltage requested for display operation disadvantageously increases. In this case, it is difficult to perform the display drive operation by using a general-purpose component.

Each of the upper electrode layers 21b, 22b, and 23b and the lower electrode layers 21d, 22d, and 23d is typically a transparent conductive film made of an indium tin oxide (ITO) but may alternatively be a transparent conductive film made of an indium zinc oxide (IZO).

Each of the upper electrode layers 21b, 22b, and 23b is formed of a plurality of strip-shaped transparent X electrode lines, which are disposed in parallel to each other on the upper transparent substrate 21a, 22a, and 23a.

Each of the lower electrode layers 21d, 22d, and 23d is formed of a plurality of strip-shaped transparent Y electrode lines, which are disposed in parallel to each other on the lower transparent substrate 21e, 22e, and 23e, which faces the upper transparent substrate 21a, 22a, and 23a, respectively. The direction in which the strip-shaped X electrode lines, which form the upper electrode layers 21b, 22b, and 23b, extend intersect the direction in which strip-shaped Y electrode lines, which form the lower electrode layers 21d, 22d, and 23d, extend when viewed in the direction perpendicular to the surfaces of the upper transparent substrates 21a, 22a, and 23a and the lower transparent substrates 21e, 22e, and 23e face each other.

An insulating thin film layer is formed between each of the pairs of the cholesteric liquid crystal layers 21c, 22c, 23c and the upper electrode layers 21b, 22b, 23b and between each of the pairs of the cholesteric liquid crystal layers 21c, 22c, 23c and the lower electrode layers 21d, 22d, 23d. The insulating thin film layer desirably has a thickness of about 0.3 μm. When the insulating thin film layer is thicker, the drive voltage requested for display operation disadvantageously increases. On the other hand, when the insulating thin film layer is thinner, leak current passing through the insulating thin film layer increases. In this case, current consumption disadvantageously increases. The insulating thin film layer is formed, for example, of a thin film made of a silicon oxide or an organic film made of a polyimide resin or an acrylic resin, which is known as an orientation stabilizing film, and any of the films described above has a relative permittivity of, for example, about five.

The cholesteric liquid crystal layers 21c, 22c, and 23c are disposed in the gaps between the upper transparent substrates 21a, 22a, 23a and the lower transparent substrates 21e, 22e, 23e, respectively.

Each of the cholesteric liquid crystal layers 21c, 22c, and 23c is formed, for example, by adding 10 to 40 weight percent (wt %) of a chiral material to a nematic liquid crystal compound. The amount of chiral material to be added described above is calculated by assuming that the total amount of the nematic liquid crystal component and the chiral material corresponds to 100 wt %.

The nematic liquid crystal compound, which may be a known one, desirably has a dielectric anisotropy (Δ∈) ranging from 15 to 25. When the dielectric anisotropy (Δ∈) is 15 or smaller, the drive voltage requested for display operation increases, and it is difficult in this case to perform the display drive operation by using a general-purpose component. On the other hand, when the dielectric anisotropy is 25 or greater, the display threshold steepness decreases, and in this case, the reliability of the liquid crystal material itself could degrade.

Further, the nematic liquid crystal compound desirably has a refractive index anisotropy (Δn) ranging from 0.18 to 0.26. When the refractive index anisotropy (Δn) is smaller than 0.18, the reflectance of the cholesteric liquid crystal layers 21c, 22c, and 23c in a planar state decreases. On the other hand, when the refractive index anisotropy (Δn) is greater than 0.26, scattering reflectance in a focal conic state increases. When a chiral material is so added to the nematic liquid crystal compound that the refractive index anisotropy (Δn) is greater than 0.26, the viscosity of the cholesteric liquid crystal layers 21c, 22c, and 23c increases, and in this case, a display response speed decreases.

The light absorbing layer 26 is disposed on the outer surface of the lower transparent substrate 23e, which faces away from the side on which light is incident. The light absorbing layer 26 not only absorbs visible light but also blocks visible light incident through the outer surface of the lower transparent substrate 23e. The light absorbing layer 26 looks therefore black when viewed with human eyes. The cholesteric liquid crystal display device 10 includes the liquid crystal display device 21 that displays a blue image, the liquid crystal display device 22 that displays a green image, and the liquid crystal display device 23 that displays a red image, as described above. When one views the cholesteric liquid crystal display device 10 with the cholesteric liquid crystal layers 21c, 22c, and 23c in the respective liquid crystal devices being in the focal conic state or a homeotropic state, the cholesteric liquid crystal display device 10 looks black. In the above description, in which the light absorbing layer 26 absorbs light of substantially all wavelengths, the light absorbing layer 26 looks black. The light absorbing layer 26 may alternatively absorb light of wavelengths other than a specific wavelength. In this case, when one views the cholesteric liquid crystal display device 10 in the focal conic state or the homeotropic state, a color tone representing the light of the specific wavelength is recognized.

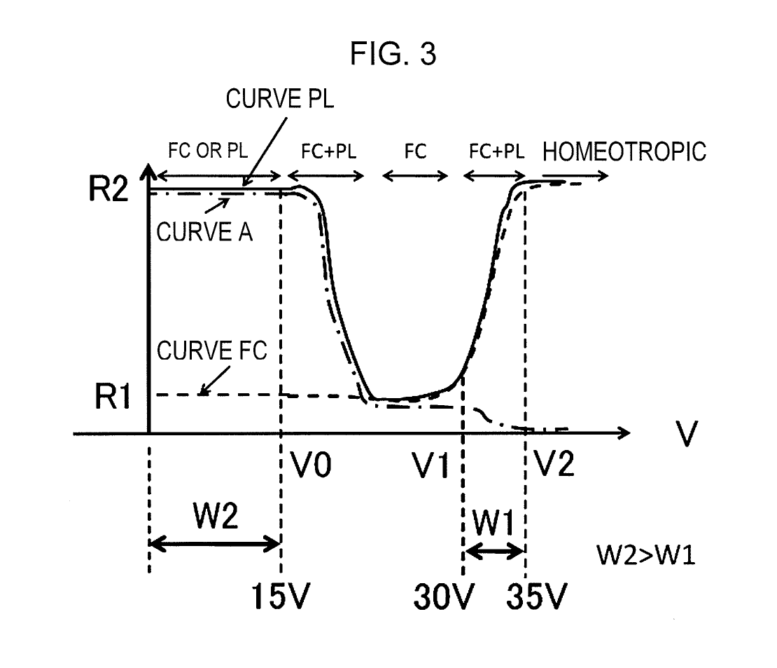

FIG. 3 depicts an example of a voltage-reflectance characteristic of the cholesteric liquid crystal layers 21c, 22c, and 23c according to the present embodiment. The horizontal axis represents the voltage (V) applied between the electrodes that sandwich each of the cholesteric liquid crystal layers 21c, 22c, and 23c, and the vertical axis represents the reflectance (%) of the cholesteric liquid crystal layer. The curves PL and FC represent the applied voltage versus the reflectance maintained when the applied voltage is removed. The curve A represents the reflectance obtained when the voltage keeps being applied.

The curve A (dashed line) depicted in FIG. 3 represents the reflectance obtained when the voltage keeps being applied versus the applied voltage. Note that the curve A represents change in reflectance of the cholesteric liquid crystal material, which is in the planar state when the applied voltage is 0 V. The reflectance of the cholesteric liquid crystal material represented by the curve A remains at reflectance R2 until a voltage V0 (15 V, for example) is reached. When the applied voltage becomes higher than V0, the reflectance decreases toward reflectance R1 as the applied voltage increases. That is, when the reflectance of the cholesteric liquid crystal material becomes R1, the cholesteric liquid crystal material becomes substantially transparent. Further, when the applied voltage becomes higher than V1, the reflectance of the cholesteric liquid crystal material further decreases. When the applied voltage becomes higher than V2, the reflectance becomes substantially zero.

The solid-line curve PL depicted in FIG. 3 represents the voltage-reflectance characteristic of the cholesteric liquid crystal layers 21c, 22c, and 23c maintained in the planar state. That is, the curve PL represents the reflectance achieved when any voltage marked along the horizontal axis is applied to the cholesteric liquid crystal layers 21c, 22c, and 23c in the planar state and the voltage is then abruptly reduced to 0 V.

In this state, even when a voltage within a voltage range W2 from the ground voltage to the voltage V0 (15 V, for example) is applied to the cholesteric liquid crystal layers 21c, 22c, and 23c, the planar state or the focal conic state of the cholesteric liquid crystal material is maintained. The reflectance therefore hardly changes even when a voltage within the voltage range W2 is applied to the cholesteric liquid crystal layers 21c, 22c, and 23c.

On the other hand, when a voltage higher than or equal to the voltage V0 is applied to the cholesteric liquid crystal layers 21c, 22c, and 23c, the states thereof become a combination of the focal conic state and the homeotropic state, and in this case, the reflectance decreases. That is, the voltage V0 is a threshold beyond which the state transitions to a transparent state. When the reflectance of the cholesteric liquid crystal material is substantially R1, the cholesteric liquid crystal material is in a low-reflectance state.

When a voltage higher than or equal to the voltage V0 is applied to the cholesteric liquid crystal layers 21c, 22c, and 23c, and then the voltage is reduced to a voltage lower than or equal to V0, the planar state is mixed with the focal conic state, and the cholesteric liquid crystal layers 21c, 22c, and 23c show the reflectance depicted in the voltage-reflectance characteristic in FIG. 3.

That is, when a voltage changing from the voltage V0 to the voltage V1 is applied to the cholesteric liquid crystal layers 21c, 22c, and 23c, the reflectance thereof decreases from the value corresponding to the voltage V0 to the value corresponding to the voltage V1. On the other hand, when a voltage changing within a voltage range W1 (voltage ranging from voltage V1 to voltage V2: voltage range from 30 to 35 V, for example) is applied to the cholesteric liquid crystal layers 21c, 22c, and 23c, the reflectance thereof increases from the value corresponding to the voltage V1 to the value corresponding to the voltage V2.

The curve FC represents the reflectance achieved when any voltage marked along the horizontal axis is applied to the cholesteric liquid crystal layers 21c, 22c, and 23c in the focal conic state and the voltage is then abruptly reduced to V0 or lower. The reflectance hardly changes even when a voltage within the voltage range W2 from the ground voltage to the voltage V0 (15 V, for example) is applied to the cholesteric liquid material in the focal conic state.

On the other hand, when a voltage higher than or equal to the voltage V0 is applied to the cholesteric liquid crystal layers 21c, 22c, and 23c, the states thereof become a combination of the focal conic state and the homeotropic state, and in this case, the transparent state in which the reflectance is substantially R1, is maintained. That is, the voltage V0 is a threshold beyond which the focal conic state transitions to the homeotropic state.

When a voltage higher than or equal to the voltage V0 is applied to the cholesteric liquid crystal layers 21c, 22c, and 23c, and the voltage is then reduced to a value smaller than or equal to V0, the focal conic state is mixed with the planar state, and in this case, the cholesteric liquid crystal layers 21c, 22c, and 23c show the reflectance depicted in the voltage-reflectance characteristic in FIG. 3.

However, when a voltage within the range from the voltage V0 to V1 is applied to the cholesteric liquid crystal layers having been in the focal conic state with a voltage within the voltage range W1 (ranging from voltage V1 to V2) applied, the state of the cholesteric liquid crystal layers transitions to the low-reflectance state, in which the reflectance is R1. On the other hand, when a voltage changing within the voltage range W1 (ranging from voltage V1 to V2) is applied to the cholesteric liquid crystal layers 21c, 22c, and 23c, the reflectance thereof increases from the value corresponding to the voltage V1 to the value corresponding to the voltage V2, as in the case described above.

That is, not only the cholesteric liquid crystal layers 21c, 22c, and 23c in the focal conic state but also the cholesteric liquid crystal layers 21c, 22c, and 23c in the planar state may show the same brightness (grayscale) by applying a voltage within the voltage range W1 to achieve the homeotropic state and then abruptly reducing the voltage to 0 V. That is, a voltage within the voltage range W1 allows the states of the cholesteric liquid crystal layers 21c, 22c, and 23c to be a combination of the focal conic state and the homeotropic state and the cholesteric liquid crystal layers 21c, 22c, and 23c to show desired brightness.

The voltage range W2 is desirably broader than the voltage range W1, as will be described later. That is, the following conditional expression is desirably satisfied:

voltage range W2>voltage range W1 Expression (1)

Each of the cholesteric liquid crystal layers 21c, 22c, and 23c is formed, for example, by adding 10 to 40 weight percent (wt %) of a chiral material to a nematic liquid crystal compound. It is known that selecting the type of nematic liquid crystal material and adjusting the amount of chiral material to be added allow the cholesteric liquid crystal layers 21c, 22c, and 23c to have the voltage-reflectance characteristic depicted in FIG. 3.

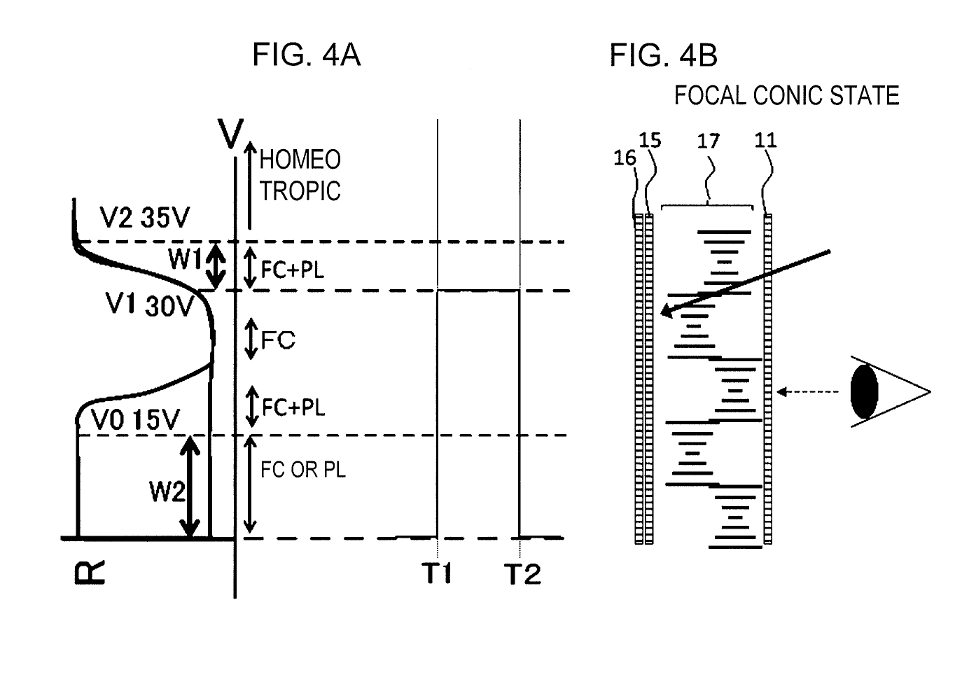

FIG. 4A describes how to maintain the focal conic state of the cholesteric liquid crystal layer 17, and FIG. 4B describes the focal conic state. In FIG. 4A, the vertical axis represents the voltage applied to the cholesteric liquid crystal layer 17, the left side of the horizontal axis represents the reflectance of the cholesteric liquid crystal layer 17, and the right side of the horizontal axis represents time. The left side of the horizontal axis in FIG. 4A depicts the relationship between the voltage applied to the cholesteric liquid crystal layer 17 and the reflectance thereof. The right side depicts the relationship between the voltage applied to the cholesteric liquid crystal layer 17 and the time in the process of keeping the cholesteric liquid crystal layer 17 in the focal conic state. The relationship between the voltage applied to the cholesteric liquid crystal layer 17 and the reflectance thereof is the same as that described with reference to FIG. 3.

When a voltage higher than or equal to the voltage V0 (15 V or higher, for example) is applied to the cholesteric liquid crystal layer 17 at time T1 as depicted in FIG. 4A, a helical structure formed of the liquid crystal molecules gradually comes loose, and the cholesteric liquid crystal layer 17 transitions to the homeotropic state, in which all the molecules follow the direction of the electric field, as the applied voltage further increases.

When the applied voltage is increased to V1 (30 V, for example) at time T2 and then the applied voltage is removed, the cholesteric liquid crystal layer 17 remains in the focal conic state.

FIG. 4B describes the focal conic state. A cholesteric liquid crystal display section depicted in FIG. 4B includes an upper electrode layer 11, the cholesteric liquid crystal layer 17, a light absorbing layer 16, which absorbs light and hence looks black, and a lower electrode layer 15. When the focal conic state is maintained, the helical axis of the helical structure formed of the liquid crystal molecules becomes parallel to the electrode surfaces, and the cholesteric liquid crystal layer 17 transitions to the focal conic state, which allows incident light to pass therethrough. The incident light is therefore hardly reflected but passes through the lower electrode layer 15 and is absorbed by the light absorbing layer 16, which looks black. As a result, the cholesteric liquid crystal layer 17 that remains in the focal conic state is recognized as black.

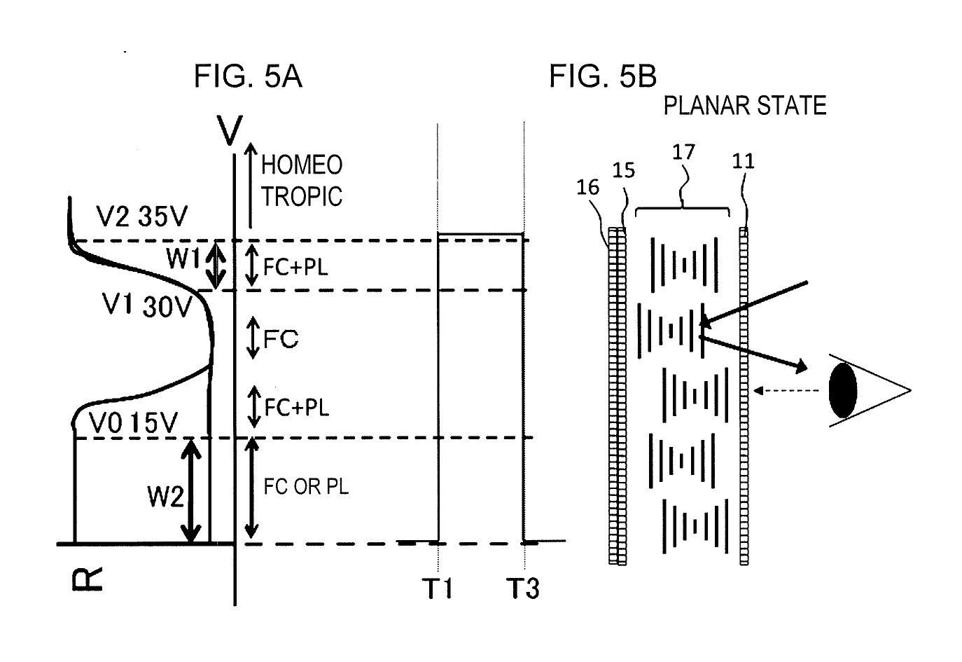

FIG. 5A describes how to maintain the planar state of the cholesteric liquid crystal layer 17, and FIG. 5B describes the planar state. In FIG. 5A, the vertical axis represents the voltage applied to the cholesteric liquid crystal layer 17, the left side of the horizontal axis represents the reflectance of the cholesteric liquid crystal layer 17, and the right side of the horizontal axis represents time. The left side of the horizontal axis in FIG. 5A depicts the relationship between the voltage applied to the cholesteric liquid crystal layer 17 and the reflectance thereof. The right side depicts the relationship between the voltage applied to the cholesteric liquid crystal layer 17 and the time in the process of keeping the cholesteric liquid crystal layer 17 in the planar state. The relationship between the voltage applied to the cholesteric liquid crystal layer 17 and the reflectance thereof is the same as that described with reference to FIG. 3.

When a voltage higher than or equal to the voltage V0 (15 V or higher, for example) is applied to the cholesteric liquid crystal layer 17 at the time T1 as depicted in FIG. 5A, the helical structure formed of the liquid crystal molecules gradually comes loose, and the cholesteric liquid crystal layer 17 transitions to the homeotropic state, in which all the molecules follow the direction of the electric field, as the applied voltage further increases.

When the applied voltage is increased to V2 (35 V, for example) at the time T2 and then the applied voltage is removed, the cholesteric liquid crystal layer 17 remains in the planar state.

FIG. 5B describes the planar state. The cholesteric liquid crystal display section depicted in FIG. 5B includes the upper electrode layer 11, the cholesteric liquid crystal layer 17, the light absorbing layer 16, which looks black, and the lower electrode layer 15. When the planar state is maintained, the helical axis of the helical structure formed of the liquid crystal molecules becomes perpendicular to the electrodes, and the cholesteric liquid crystal layer 17 transitions to the planar state, in which incident light is reflected. Part of the incident light, specifically, light of a wavelength λ determined by the product of the helical pitch P of the helical structure and the refractive index n of the liquid crystal material, shows the highest reflection intensity. When the cholesteric liquid crystal layer 17 is formed by stacking layers corresponding to the red, blue, and green, the cholesteric liquid crystal display section is recognized as white.

Consider a case where the voltage applied to the cholesteric liquid crystal material is maintained at an intermediate value between V1 (30 V, for example) and V2 (35 V, for example), and the applied voltage is then abruptly reduced to a predetermined low voltage that is lower than or equal to the voltage V0 (15 V or lower, for example) and substantially zero. In this case, the helical structure formed of the liquid crystal molecules transitions to a combination of the planar state and the focal conic state, in which a displayed image may show intermediate brightness (intermediate grayscale).

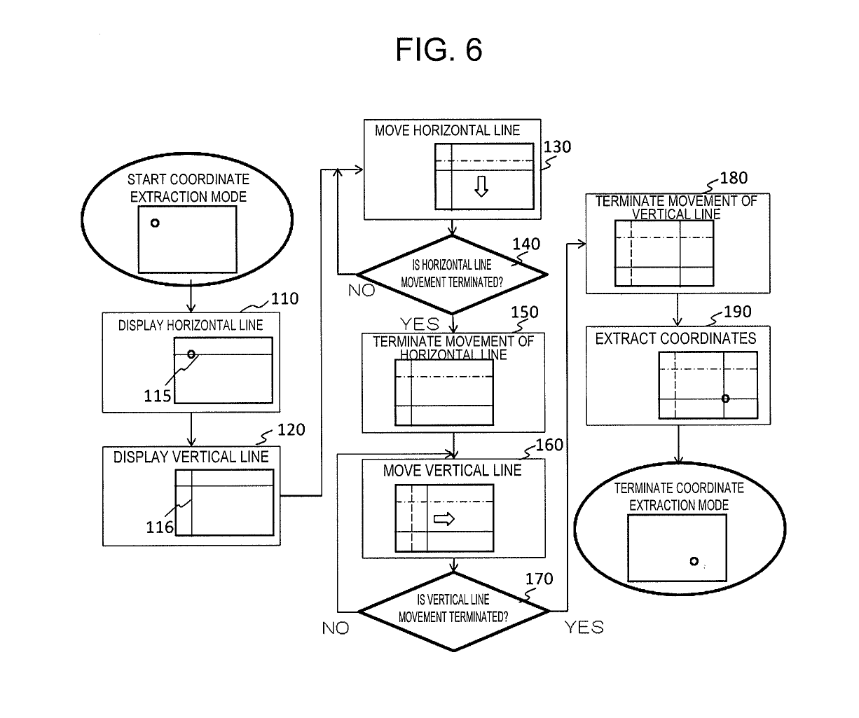

FIG. 6 describes a coordinate extraction mode in the display apparatus 30 including the cholesteric liquid crystal display device 10 according to the first embodiment.

In the first embodiment, to move a vertical black line 116 and a horizontal black line 115 from default positions to coordinates that are desired to be extracted, only the vertical black line 116 is first moved and then the horizontal black line 115 is moved.

The following description of the coordinate extraction mode will be made by representatively using one of the liquid crystal device 21 that displays a blue image, the liquid crystal device 22 that displays a green image, and the liquid crystal device 23 that displays a red image, which form the cholesteric liquid crystal display device 10.

Each of the cholesteric liquid crystal layers in the cholesteric liquid crystal device 10 has a plurality of pixels arranged in rows and columns, which form a liquid crystal display screen. The X electrode lines extend in the column direction, and the Y electrode lines extend in the row direction.

When the coordinate extraction mode starts, the display apparatus 30 operates as follows:

In a horizontal line displaying step 110, the display apparatus 30 applies the sum of the voltage applied to a Y electrode line set as a default and the voltage applied to the plurality of X electrode lines to a plurality of pixels on the default Y electrode line. When the voltage described above is applied, the plurality of pixels on the default Y electrode line become transparent and show the brightness before selected. As a result, the plurality of pixels on the Y electrode line display a black line, whereby the horizontal black line 115 is displayed on the Y electrode line of the cholesteric liquid crystal display device 10.

The application of the voltage that achieves the transparent state to the plurality of pixels on the Y electrode line is maintained until a vertical line displaying step 120 is completed. Note that, to display a black line, the cholesteric liquid crystal material does not necessarily become transparent at all the plurality of pixels on the Y electrode line. That is, part of the plurality of pixels on the Y electrode line may display a black line, or a plurality of pixels intermittently arranged along a column or a row may display a black line.

In the vertical line displaying step 120, the display apparatus 30 applies the sum of the voltage applied to an X electrode line set as a default and the voltage applied to the plurality of Y electrode lines to a plurality of pixels on the default X electrode line. When the voltage is applied as described above, the plurality of pixels on the default X electrode line transitions to the homeotropic state and shows the brightness before selected. As a result, the plurality of pixels on the X electrode line display a black line, and the vertical black line 116 is displayed on the X electrode line of the cholesteric liquid crystal display device 10.

The application of the voltage that achieves the transparent state to the plurality of pixels on the X electrode line is maintained until a horizontal line moving step 130 is completed. Note that, to display a black line, the cholesteric liquid crystal material does not necessarily become transparent at all the plurality of pixels on the X electrode line. That is, part of the plurality of pixels on the X electrode line may display a black line, or a plurality of pixels intermittently arranged along a column or a row may display a black line.

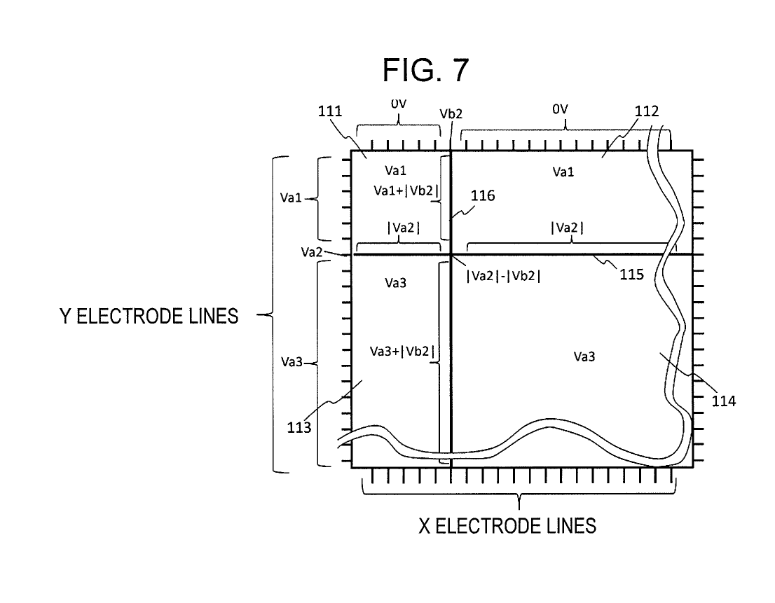

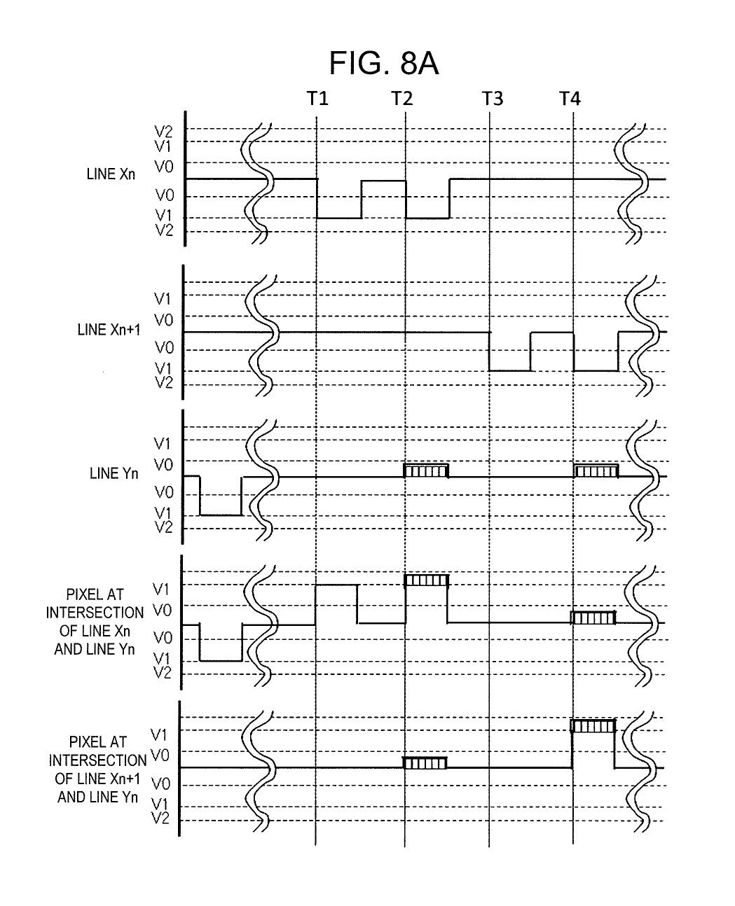

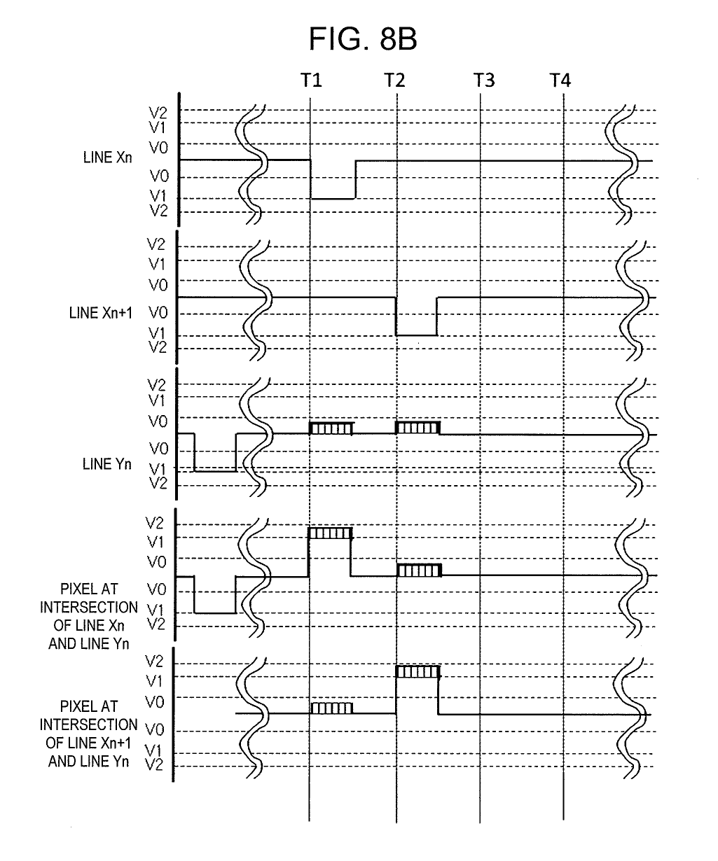

In the horizontal line moving step 130, the display apparatus 30 sequentially moves the black line from the plurality of pixels on the Y electrode line set as the default to the plurality of pixels on a specified Y electrode line. To move the black line, a black line movement sequence depicted in FIGS. 7 and 8B is carried out. The black line movement sequence includes applying the voltage that achieves the transparent state to pixels.

In a horizontal line movement termination judging step 140, the display apparatus 30 judges whether the black line has been moved to the specified Y electrode line. When the black line has not been moved to the specified Y electrode line, the control returns to the horizontal line moving step 130. On the other hand, when the black line has been moved to the specified Y electrode line, the control proceeds to a horizontal line movement terminating step 150.

In the horizontal line movement terminating step 150, the display apparatus 30 applies a voltage that achieves a cholesteric state to the specified Y electrode line and maintains the state.

In a vertical line moving step 160, the display apparatus 30 moves the black line to a specified X electrode line by carrying out a black line movement/voltage application sequence including sequentially applying the voltage that achieves the transparent state to each X electrode line from the X electrode line set as the default to the specified X electrode line. The black line movement/voltage application sequence will be described with reference to FIGS. 7 and 8B.

In a vertical line movement termination judging step 170, the display apparatus 30 judges whether the black line has been moved to the specified X electrode line. When the black line has not been moved to the specified X electrode line, the control returns to the vertical line moving step 160. On the other hand, when the black line has been moved to the specified X electrode line, the control proceeds to a vertical line movement terminating step 180.

In the vertical line movement terminating step 180, the display apparatus 30 applies the voltage that achieves the transparent state to the specified X electrode line and maintains the state.

In a coordinate extracting step 190, the display apparatus 30 extracts the coordinates corresponding to the specified Y and X electrode lines. The display apparatus 30 then sequentially allows the Y electrodes line and X electrode lines to hold the brightness values thereof and the brightness values to be fixed. The coordinate extraction mode is then terminated.

The above description has been made with reference to the case where the coordinates to be extracted are specified by using one vertical black line 116 and one horizontal black line 115. The number of coordinates to be simultaneously extracted is, however, not limited to one. That is, a plurality of sets of coordinates may be extracted by using two or more vertical black lines 116 and one horizontal black line 115. Alternatively, a plurality of sets of coordinates may be extracted by using one vertical black line 116 and two or more horizontal black lines 115. Still alternatively, a plurality of sets of coordinates may be extracted by using two or more vertical black lines 116 and two or more horizontal black lines 115.

FIG. 7 depicts voltage application to the X electrode lines and the Y electrode lines in the vertical line moving step 160.

FIG. 7 depicts the display section of the cholesteric liquid crystal display device 10, the Y electrode lines, the X electrode lines, which intersect the Y electrode lines at right angles, the vertical black line 116 on an X electrode line, the horizontal black line 115 on a Y electrode line, and display areas 111, 112, 113, and 114. FIG. 7 also depicts voltage application to the X electrode lines and the Y electrode lines at the time when the user is about to move the vertical black line 116 to the X electrode line immediately adjacent thereto on the right side and hold and fix intermediate brightness (grayscale) to the pixels on the X electrode line.

At this point, to display the vertical black line 116, the X driver 39 applies a negative voltage that falls within the range from the voltage V0, which achieves the transparent state, to the voltage V1 and has an absolute value Vb2 to the X electrode line immediately above the vertical black line 116. The X driver 39 applies 0 V to the other X electrode lines. That is, the X driver 39 keeps applying the voltage Vb2, which achieves the transparent state, during the display period to the X electrode line that is displaying the vertical black line 116.

On the other hand, to display the horizontal black line 115, the Y driver 38 applies a negative voltage to the Y electrode line immediately below the horizontal black line 115. The absolute value of the negative voltage applied to the Y electrode line is Va2 that falls within the range from V0 to V1. As a result of the application of the negative voltage Va2 to the Y electrode line, the cholesteric liquid crystal material at the plurality of pixels on the Y electrode line transitions to the homeotropic state. The Y driver 38 further applies a voltage Va1 or Va3 to the Y electrode lines other than the Y electrode line immediately below the horizontal black line 115, the choice between Va1 or Va3 made in accordance with the brightness values of the pixels to which each of the other Y electrode lines is connected. The brightness values of pixels are those held by the pixels before the vertical black line 116 moves from the adjacent X electrode line.

The CPU 50 produces display data 48 on the brightness values of pixels based on the image data 51 held in the CPU 50 and outputs the produced display data 48 to the control circuit 37. The control circuit 37 outputs the display data 48 on the brightness values of pixels to control the voltages applied by the Y driver 38 to the Y electrodes.

That is, the Y driver 38 keeps applying the voltage that achieves the transparent state to the Y electrode line that is displaying the horizontal black line 115 until the vertical line moving step 160 is completed. Further, the Y driver 38 applies voltages to the Y electrode lines connected to the pixels on the vertical black line 116 except the Y electrode line that is displaying the horizontal black line 115, the voltages determined in accordance with the brightness value of the pixels but lower than or equal to the voltage V0.

In the horizontal line moving step 130, the Y driver 38 and the X driver 39 are functionally reversed.

In the example, the voltage Va1 is applied to the pixels present in the display areas 111 and 112, and the voltage Va3 is applied to the pixels present in the display areas 113 and 114. A voltage Va1+|Vb2| is applied to the pixels on the vertical black line 116 and between the display area 111 and the display area 112. A voltage Va3+|Vb2| is applied to the pixels on the vertical black line 116 and between the display area 113 and the display area 114. A voltage |Va2|−|Vb2| is applied to the pixel present at the intersection where the vertical black line 116 intersects the horizontal black line 115. The voltage |Va2|−|Vb2| is substantially 0 V. The voltage Va2 is applied to the pixels on the horizontal black line 115 except the pixel present at the intersection described above.

Each of the voltages Va1+|Vb2| and Va3+|Vb2| and the fixed voltage Va2 is lower than or equal to the voltage V1 and achieves the transparent state. The voltage Vb2, which is applied through the X electrode line that is displaying the vertical black line, is a fixed value, whereas the voltages Va1 and Va3, which are applied through the Y electrode lines other than that displaying the horizontal black line, depend on the brightness values held by the pixels immediately below the vertical black line 116.

To transfer the vertical black line 116 displayed on an X electrode line to the following X electrode line, voltages within the voltage range W1 (between voltages V2 and V1) are applied to the pixels on the vertical black line so that the pixels hold their brightness values. To set the voltages applied to the pixels at values within the voltage range W1 (between voltages V2 and V1), the fixed potential Vb2 applied to the current X electrode line is set at the voltage V1.

That is, the voltages Va1 and Va3 are so set in accordance with the voltage-reflectance characteristic depicted in FIG. 3 that when the voltage V1 is applied to the X electrode line immediately below the vertical black line 116, the pixels on the X electrode line show the brightness values held by the pixels. When the voltage Vb2 is abruptly reduced from the voltage V1 to the ground voltage (0 V) with the voltage Va1+|V1| or the voltage Va3+|V1| applied to the pixels, the brightness values of the pixels are held by and fixed to the pixels. The brightness does not change in any of the areas 111, 112, 113, and 114 except the vertical black line 116. The reason for this is that the voltages Va1 and Va3 fall within the voltage range W2 (between 0 V and voltage V0). To allow the voltages Va1+|V1| and Va3+|V1| to be values within the voltage range W1 with the voltages Va1 and Va3 falling within the voltage range W2, W2>W1 are satisfied in the voltage-reflectance characteristic described with reference to FIG. 3.

On the other hand, the voltages Va1 and Va3 are applied to the Y electrode lines before the fixed voltage Vb2, which is the voltage applied to the current X electrode line, is increased to the voltage V1, and the voltages Va1 and Va3 are maintained at least until the end of the period of the application of the voltage that allows the brightness values of the pixels to be held by and fixed to the pixels.

Further, in the step 160, in which the vertical black line 116 is moved, the fixed voltage Va2 is maintained across the Y electrode line immediately below the horizontal black line 115. The horizontal black line 115 therefore keeps being displayed.

The above description of the operation of moving the vertical black line 116 holds true for the description of the operation of moving the horizontal black line 115 by replacing the X electrode lines with the Y electrode lines, the vertical black line 116 with the horizontal black line 115, and the Y driver with the X driver. In the step 130, in which the horizontal black line 115 is moved, the voltage Vb2 is maintained across the X electrode line immediately above the vertical black line 116.

FIGS. 8A and 8B are waveform diagrams depicting voltage application sequences for moving the vertical black line 116 and the horizontal black line 115, respectively. Specifically, FIGS. 8A and 8B are waveform diagrams depicting voltage application sequences for moving the vertical black line 116 between arbitrary adjacent two X electrode lines and moving the horizontal black line 115 between arbitrary adjacent two Y electrode lines in the cholesteric liquid crystal display device 10, respectively. In FIGS. 8A and 8B, the top waveform diagram depicts a signal in the n-th X electrode line Xn associated with the vertical black line 116, and a waveform diagram below the top waveform diagram depicts a signal in the following X electrode line Xn+1. Below the diagrams described above are a waveform diagram representing a signal in the n-th Y electrode line Yn associated with the horizontal black line 115 and a waveform diagram representing a signal in the following Y electrode line Yn+1. The horizontal axis represents time, and the vertical axis represents the voltage applied to the pixels on an electrode line of interest.

The voltage application sequence depicted in FIG. 8A is a typical voltage application sequence performed in the vertical line moving step 160 when the vertical black line 116 is moved from the n-th X electrode line Xn to the following X electrode line Xn+1 and performed on the pixels disposed along the X electrode lines Xn and Xn+1.

The voltage application sequence performed on the pixels along the X electrode line Xn in the period from time T1 to T2 is a black line holding voltage application sequence for holding a black line and fixing it to the pixels immediately below the X electrode line Xn.

The black line holding voltage application sequence includes a first action of applying a voltage −V1 for holding the focal conic state, in which the reflectance decreases, to the pixels on a selected X electrode line Xn. The black line holding voltage application sequence further includes a second action of applying the ground voltage to the pixels on the selected X electrode line Xn in order to hold the focal conic state.

On the other hand, a black line holding voltage application sequence for holding a black line on a selected Y electrode line Yn is so performed before the time T1 that the black line is held by the pixels on the selected Y electrode line Yn, and no voltage is therefore applied to any of the Y electrode lines during the period from the time T1 to T2. As a result, the ground voltage is applied to the pixels immediately below the selected X electrode line Xn before the time ti, whereby the same voltage as that applied to the X electrode line Xn is applied to the pixels on the selected X electrode line Xn during the period from the time T1 to T2.

A voltage application sequence performed on the pixels disposed along the X electrode line Xn during the period from the time T2 to T3 is a redisplay voltage application sequence for refixing the brightness values of the pixels thereto and redisplaying the line image.

To add the brightness values to the pixels to form the line image, the redisplay voltage application sequence includes a first action of applying the voltage −V1 (−30 V, for example) to the selected Xn electrode line so that a voltage within the range from the voltage V1 to V2 is applied to the pixels on the X electrode line Xn. The redisplay voltage application sequence further includes a second action of applying the ground voltage to the pixels on the selected X electrode line Xn in order to hold the brightness values of the pixels.

On the other hand, voltages according to the brightness values of the pixels on the black line are applied to the Y electrode lines in the first action performed from the time T2 to T3, and the ground voltage is applied to the Y electrode lines when the ground voltage is applied to the X electrode line Xn.

In the configuration described above, when a black line is moved from an arbitrary electrode line Xn to the following electrode line Xn+1, a typical voltage application sequence requests four actions at the minimum. Further, there are two actions for making the cholesteric liquid crystal material transparent, and whenever the action is carried out, current flows through the liquid crystal material because the helical structure collapses. Moreover, charging and discharging are repeated twice in the X electrode lines.

The voltage application sequence depicted in FIG. 8B is a voltage application sequence in the first embodiment performed in the vertical line moving step 160 when the vertical black line 116 is moved from an arbitrary X electrode line Xn to the following X electrode line Xn+1 and performed on the pixels immediately below the X electrode lines Xn and Xn+1.

The voltage application sequence for displaying the vertical black line 116 on the pixels immediately below the X electrode line Xn performed in the period from the time T1 to T2 is a black line moving voltage application sequence for applying the voltage that achieves the transparent state of the cholesteric liquid crystal material to the electrode line Xn and continuously applying voltages that fix brightness values to the pixels on the vertical black line 116 to display a line image to the Y electrode lines for the same period from the time T1 to T2.

The black line moving voltage application sequence includes a first action and a second action. In the first action, the voltage −V1, which achieves the transparent state of the cholesteric liquid crystal material, is applied to the plurality of pixels on the selected X electrode line Xn. Thereafter, to fix the brightness values to the pixels and redisplay the line image formed of the plurality of pixels, voltages ranging from the ground voltage to the voltage V0 and according to the brightness values of the pixels are applied to the Y electrode lines, while the voltage −V1 keeps being applied to the X electrode line Xn. In the second action in the black line moving voltage application sequence, the voltage applied to the X electrode line Xn is set at the ground voltage in order to hold the brightness values of the pixels and fix them to the pixels. As a result, after the first action is completed, voltages ranging from the voltage V1 to V2 are applied to the pixels, and in the second action, voltages ranging from the ground voltage to the voltage V0 are applied to the pixels.

On the other hand, a black line holding voltage application sequence is performed on a selected Y electrode line Yn before the time T1 so that a black line is held on the selected Y electrode line, whereby a line image including a black line is held by the pixels on the selected Y electrode line during the period from the time T1 to T2. Further, in the first action, voltages according to the brightness values of the pixels immediately below the selected X electrode but lower than or equal to the voltage V0 are applied to the Y electrode lines other than the selected Y electrode line Yn. In the period of the second action, the voltages applied to the Y electrode lines transition to voltages according to the brightness values of the pixels on a vertical black line 216 to which the vertical black line have been moved.

As described above, the black line moving voltage application sequence performed on the selected X electrode requests two actions, and the application of the voltages according to the brightness values of the pixels associated with the selected X electrode to the Y electrode lines is requested every two actions.

In the period from the time T2 to T3, the black line moving voltage application sequence performed in the period from the time T1 to T2 is repeated.

As described above, the voltage application sequence for moving the vertical black line 116 from an arbitrary X electrode line Xn to the following X electrode line in the first embodiment includes two actions. In one of the two actions, the cholesteric liquid crystal material is made transparent, and whenever the action is carried out, current flows through the cholesteric liquid crystal material because the helical structure collapses. The number of current flow actions is, however, one in the black line moving voltage application sequence. Further, charging and discharging are repeated once in the X electrode lines in the black line moving voltage application sequence.

A black line is therefore moved in a shorter period in the display apparatus 300 according to the first embodiment. Further, in the display apparatus 300 according to the first embodiment, since the black line moving voltage application sequence in the first embodiment is used to move a black line, the amount of current consumed in the coordinate extraction mode is reduced.

### Second Embodiment

The first embodiment has been described with reference to the case where the vertical black line 116 and the horizontal black line 115 are moved from default positions to coordinates that are desired to extracted by first moving only the vertical black line 116 and then moving the horizontal black line 115.

On the other hand, a second embodiment will be described with reference to a case where the vertical black line 116 and the horizontal black line 115 are moved from default positions to coordinates that are desired to extracted by alternately moving the vertical black line 116 and the horizontal black line 115.

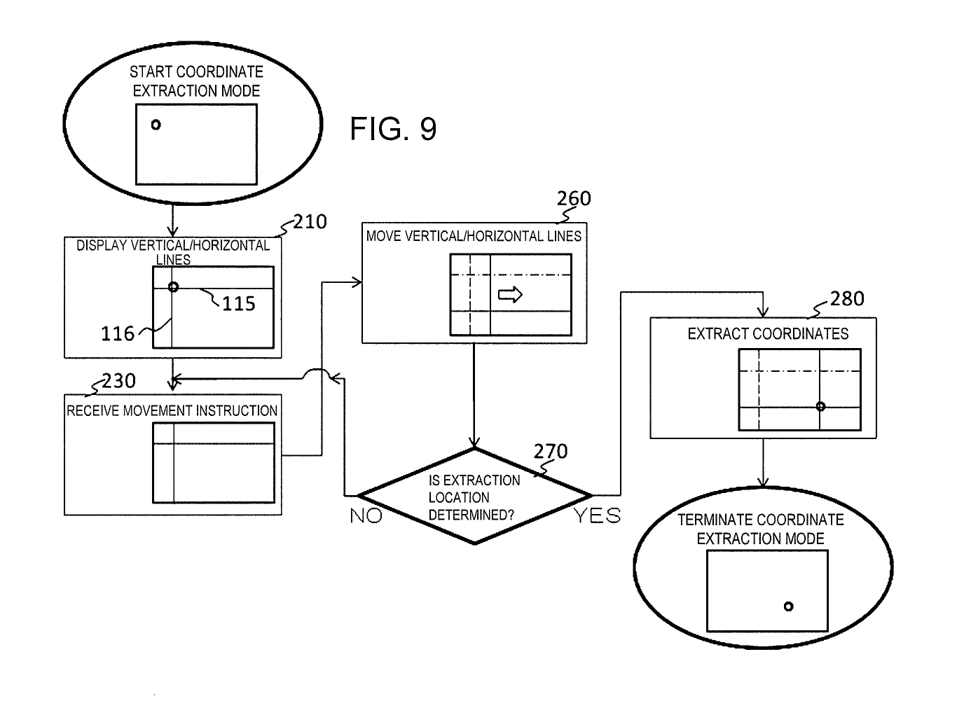

FIG. 9 describes a coordinate extraction mode according to the second embodiment in the display apparatus 30 including the cholesteric liquid crystal display device 10.

The following description of the coordinate extraction mode will be made by representatively using one of the liquid crystal device 21 that displays a blue image, the liquid crystal device 22 that displays a green image, and the liquid crystal device 23 that displays a red image, which form the cholesteric liquid crystal display device 10.

Each of the cholesteric liquid crystal layers in the cholesteric liquid crystal device 10 has a plurality of pixels arranged in rows and columns, which form a liquid crystal display screen. The X electrode lines extend in the column direction, and the Y electrode lines extend in the row direction.

When the coordinate extraction mode starts, the display apparatus 30 operates as follows:

In a vertical/horizontal line displaying step 210, in the display apparatus 30, positions of the X electrode line and the Y electrode line where black lines are displayed are set in advance. The display apparatus 30 applies a voltage that achieves the transparent state to the X electrode line and the Y electrode line in the preset positions to display a vertical black line 216 and a horizontal black line 215 on the X electrode line and the Y electrode line in the cholesteric liquid crystal display device 10. The voltage that achieves the transparent state keeps being applied to the X electrode line and the Y electrode line until an extraction location determining step 270 is completed. Note that, to display a black line, the cholesteric liquid crystal material does not necessarily transition to the homeotropic state at all the plurality of pixels on the Y electrode line. That is, part of the plurality of pixels on the Y electrode line may display a black line, or a plurality of pixels intermittently arranged along a column or a row may display a black line.

Note that, to display a black line, the cholesteric liquid crystal material does not necessarily become transparent at all the plurality of pixels on the X electrode line. That is, part of the plurality of pixels on the X electrode line may display a black line, or a plurality of pixels intermittently arranged along a column or a row may display a black line.

In a movement instruction receiving step 230, the display apparatus 30 receives a movement instruction.

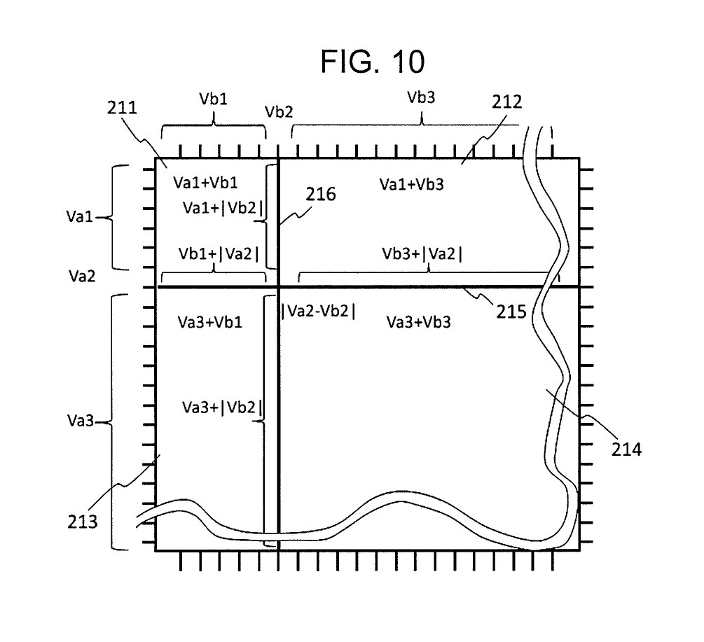

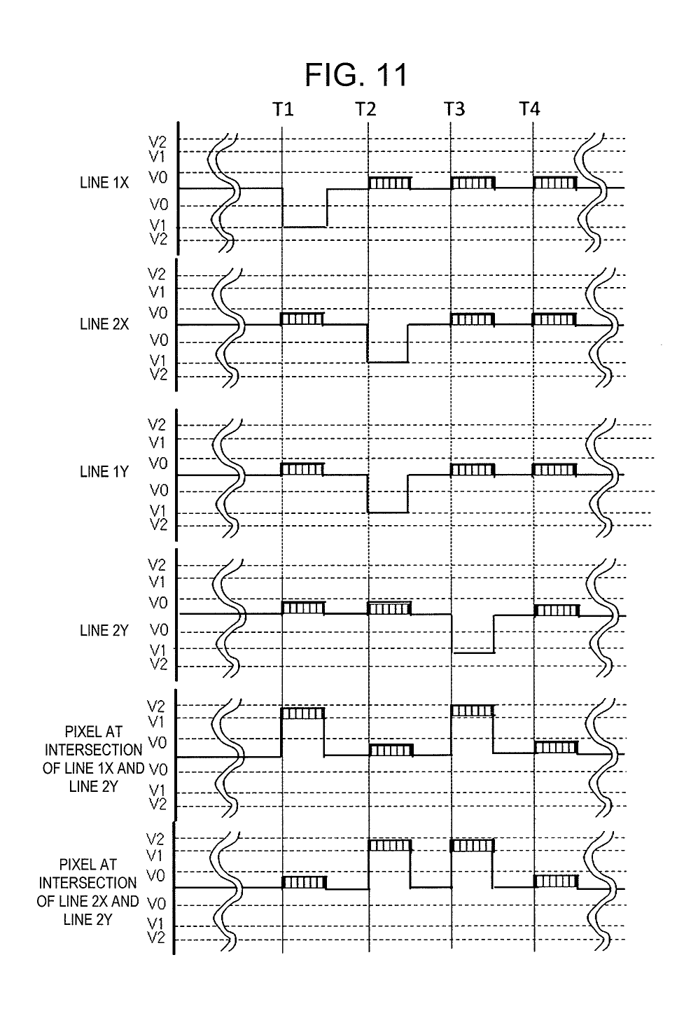

In a vertical/horizontal line moving step 260, the display apparatus 30 moves the vertical black line 216 and the horizontal black line 215 from the positions where the vertical black line 216 and the horizontal black line 215 are displayed on the X and Y electrode lines at the time when the instruction is received to the specified X and Y electrode lines. To this end, the display apparatus 30 performs a black line moving voltage application sequence depicted in FIGS. 10 and 11 to move the vertical black line 216 and the horizontal black line 215 to the specified X and Y electrode lines.

When the display apparatus 30 judges in the extraction location determining step 270 that no movement instruction of the vertical black line 216 and the horizontal black line 215 has been issued, the display apparatus 30 carries out a coordinate extracting step 280. On the other hand, when the display apparatus 30 judges that a movement instruction of the vertical black line 216 and the horizontal black line 215 has been issued, the display apparatus 30 carries out the movement instruction receiving step 230.

In the coordinate extracting step 280, the display apparatus 30 extracts the X coordinate in the display section from the position of the specified X electrode line and extracts the Y coordinate in the display section from the position of the specified Y electrode line in the cholesteric liquid crystal display device 10. The display apparatus 30 then restores the brightness values of the pixels on the vertical black line 216 and the brightness values of the pixels on the horizontal black line 215. The coordinate extraction mode is then terminated.

In the above description, the coordinates to be extracted are specified by using one vertical black line 216 and one horizontal black line 215, but the number of coordinates to be simultaneously extracted is not limited to one. That is, a plurality of sets of coordinates may be extracted by using two or more vertical black lines 216 and one horizontal black line 215. Alternatively, a plurality of sets of coordinates may be extracted by using one vertical black line 216 and two or more horizontal black lines 215. Still alternatively, a plurality of sets of coordinates may be extracted by using two or more vertical black lines 216 and two or more horizontal black lines 215.

FIG. 10 depicts voltage application to the X electrode lines and the Y electrode lines in the vertical/horizontal line moving step 260.

FIG. 10 depicts the display section of the cholesteric liquid crystal display device 10, the Y electrode lines, the X electrode lines, which intersect the Y electrode lines at right angles, the vertical black line 216 on an X electrode line, the horizontal black line 215 on a Y electrode line, and display areas 211, 212, 213, and 214. FIG. 10 also depicts voltage application to the X electrode lines and the Y electrode lines at the time when the user is about to move the vertical black line 216 to the X electrode line immediately adjacent thereto on the right side and hold and fix intermediate brightness (grayscale) to the pixels on the X electrode line.

At this point, to display the vertical black line 216, the X driver 39 applies a negative voltage that falls within the range from the voltage V0, which achieves the transparent state, to the voltage V1 and has the absolute value Vb2 to the X electrode line immediately below the vertical black line 216. The X driver 39 further applies a voltage Vb1 or Vb3 to the X electrode lines other than the X electrode line immediately above the vertical black line 216, the choice of Vb1 or Vb3 made in accordance with the brightness values of the pixels to which each of the other X electrode lines is connected.

The brightness values of the pixels are those held by the pixels before the horizontal black line 215 moves from the adjacent Y electrode line.

The CPU 50 produces display data 48 on the brightness values of the pixels based on the image data 51 held in the CPU 50 and outputs the produced display data 48 to the control circuit 37. The control circuit 37 outputs the display data 48 on the brightness values of the pixels to control the voltages applied by the X driver 39 to the X electrodes.

That is, the X driver 39 keeps applying the fixed voltage Vb2, which achieves the transparent state, during the display period to the X electrode line that is displaying the vertical black line 216.

Further, the X driver 39 applies voltages to the X electrode lines connected to the pixels on the horizontal black line 215 except the X electrode line that is displaying the vertical black line 216, the voltages determined in accordance with the brightness values of the pixels. The voltages applied to the X electrode lines are so set that the voltage Vb1-Va1, the voltage Vb1-Va3, the voltage Vb3-Va1, and the voltage Vb3-Va3 applied to the pixels are lower than or equal to the voltage V0, as will be described with reference to FIG. 11. The voltages Va1 and Va3 are voltages outputted from the Y driver 38.

On the other hand, to display the horizontal black line 215, the Y driver 38 applies a negative voltage that falls within the range between V0, which achieves the transparent state, and V1 and has the absolute value Vat to the Y electrode line immediately below the horizontal black line 215.

The Y driver 38 further applies the voltage Va1 or Va3 to the Y electrode lines other than the Y electrode line immediately below the horizontal black line 215, the choice of Va1 or Va3 made in accordance with the brightness values of the pixels to which each of the other Y electrode lines is connected.

The brightness values of the pixels are those held by the pixels before the vertical black line 216 moves from the adjacent X electrode line.

The CPU 50 produces display data 48 on the brightness values of the pixels based on the image data 51 held in the CPU 50 and outputs the produced display data 48 to the control circuit 37. The control circuit 37 outputs the display data 48 on the brightness values of the pixels to control the voltages applied by the Y driver 38 to the Y electrodes.

That is, the Y driver 38 keeps applying the fixed voltage Vat, which achieves the transparent state, during the display period to the Y electrode line that is displaying the horizontal black line 215.

Further, the Y driver 38 applies voltages to the Y electrode lines connected to the pixels on the vertical black line 216 except the Y electrode line that is displaying the horizontal black line 215, the voltages determined in accordance with the brightness values of the pixels. The voltages applied to the Y electrode lines are so set that the voltage Vb1-Va1, the voltage Vb1-Va3, the voltage Vb3-Va1, and the voltage Vb3-Va3 applied to the pixels are lower than or equal to the voltage V0.

In the example, the voltage Va1-Vb1 is applied to the pixels present in the display area 211. The voltage Va1-Vb3 is applied to the pixels present in the display area 212. The voltage Va3-Vb1 is applied to the pixels present in the display area 213. The voltage Va3-Vb3 is applied to the pixels present in the display area 214.

A voltage Va1+|Vb2| is applied to the pixels on the vertical black line 216 and between the display area 211 and the display area 212. A voltage Va3+|Vb2| is applied to the pixels on the vertical black line 216 and between the display area 213 and the display area 214. A voltage |Va2|−|Vb2| is applied to the pixel present at the intersection where the vertical black line 216 intersects the horizontal black line 215. The voltage |Va2|−|Vb2| is substantially 0 V. A voltage Vb1+|Va2| is applied to the pixels on the horizontal black line 215 and between the display area 211 and the display area 213. A voltage Vb3+|Va2| is applied to the pixels on the horizontal black line 215 and between the display area 212 and the display area 214.

Each of the voltages Va1+|Vb2|, Va3+|Vb2|, Vb1+|Va2|, and Vb3+|Va2| is lower than or equal to the voltage V1 and achieves the transparent state. The voltage Vb2, which is applied through the X electrode line that is displaying the vertical black line, is a fixed value, whereas the voltages Va1 and Va3, which are applied through the Y electrode lines other than that displaying the horizontal black line, depend on the brightness values held by the pixels immediately below the vertical black line 216. Similarly, the voltage Vat, which is applied through the Y electrode line that is displaying the horizontal black line, is a fixed value, whereas the voltages Vb1 and Vb3, which are applied through the X electrode lines other than that displaying the vertical black line, depend on the brightness values held by the pixels immediately below the horizontal black line 215.

To transfer the vertical black line 216 displayed on an X electrode line to the following X electrode line, voltages within the voltage range W1 (between voltages V2 and V1) are applied to the pixels on the vertical black line 216 so that the brightness values of the pixels are held by and fixed to the pixels. That is, the potential Vb2 applied to the current X electrode line is desirably the voltage V1. As a result, the voltages applied to the pixels are set at values within the voltage range W1 (between voltages V2 and V1).

That is, the voltages Va1 and Va3 are so set in accordance with the voltage-reflectance characteristic depicted in FIG. 3 that when the voltage V1 is applied to the X electrode line immediately below the vertical black line 216, the pixels on the X electrode line show the brightness values held by the pixels. When the voltage V1 is abruptly set at the voltage Vb1 or Vb3 with the voltage Va1+|V1| or the voltage Va3+|V1| applied to the pixels, and the voltages applied to the pixels are set at 0 V, the brightness values of the pixels are held by and fixed to the pixels. That is, the voltages Va1-Vb1, Va1-Vb3, Va3-Vb1, and Va3-Vb3 fall within the voltage range W2 (between 0 V and voltage V0).

Now, the condition of the voltages Va1+|V1| and Va3+|V1| falling within the voltage range W1 is called a first condition (voltage V2−voltage V1>voltage Va1 and voltage V2−voltage V1>voltage Va3).

Further, the condition of the voltage V0 (voltage within voltage range W2)>voltage Va1−voltage Vb1, voltage V0 (voltage within voltage range W2)>voltage Va1−voltage Vb3, voltage V0 (voltage within voltage range W2)>voltage Va3−voltage Vb1, and voltage V0 (voltage within voltage range W2)>voltage Va3−voltage Vb3 is called a second condition.

To satisfy the first and second conditions, voltage width of voltage range W2>voltage width of voltage range W1 (voltage V2−voltage V1) are satisfied in the voltage-reflectance characteristic described with reference to FIG. 3.

The voltages Va1 and Va3 are applied to the Y electrode lines other than the Y electrode line displaying the horizontal black line before the potential of the current X electrode line is increased from Vb2 to the voltage V1, and the voltages Va1 and Va3 are maintained at least until the end of the period of the application of the voltage that allows the brightness values of the pixels to be held by and fixed to the pixels.

Further, during the period in which the vertical black line 216 is moved, the fixed voltage Va2 is maintained across the Y electrode line immediately below the horizontal black line 215. The horizontal black line 215 therefore keeps being displayed.

On the other hand, to transfer the horizontal black line 215 displayed on a Y electrode line to the following Y electrode line, voltages within the voltage range W1 (between voltages V2 and V1) are applied to the pixels on the horizontal black line 215 so that the brightness values of the pixels are held by and fixed to the pixels. That is, the voltage Va2 applied to the current Y electrode line is desirably the voltage V1. As a result, the voltages applied to the pixels are set at values within the voltage range W1 (between voltages V2 and V1).

That is, the voltages Vb1 and Vb3 are so set in accordance with the voltage-reflectance characteristic depicted in FIG. 3 that when the voltage V1 is applied to the Y electrode line immediately above the horizontal black line 215, the pixels on the Y electrode line show the brightness values held by the pixels. When the voltage V1 is abruptly set at the voltage Va1 or Va3 and the voltages applied to the pixels are set at 0 V with the voltage Vb1+|V1| or the voltage Vb3+|V1| applied to the pixels, the brightness values of the pixels are held by and fixed to the pixels. That is, the voltages Vb1-Va1, Vb1-Va3, Vb3-Va1, and Vb3-Va3 fall within the voltage range W2 (between 0 V and voltage V0).

Now, the condition of the voltages Va1+|V1| and Va3+|V1| falling within the voltage range W1 is called a first condition (voltage V2−voltage V1>voltage Va1 and voltage V2−voltage V1>voltage Va3). Further, the condition of the voltage V0 (voltage within voltage range W2)>voltage Va1−voltage Vb1, voltage V0 (voltage within voltage range W2)>voltage Va1−voltage Vb3, voltage V0 (voltage within voltage range W2)>voltage Va3−voltage Vb1, and voltage V0 (voltage within voltage range W2)>voltage Va3−voltage Vb3 is called a second condition. To satisfy the first and second conditions, voltage width of voltage range W2>voltage width of voltage range W1 (voltage V2−voltage V1) are satisfied in the voltage-reflectance characteristic described with reference to FIG. 3.

The voltages Vb1 and Vb3 are applied to the X electrode lines other than the X electrode line displaying the vertical black line before the potential of the current Y electrode line is increased from Va2 to the voltage V1, and the voltages Vb1 and Vb3 are maintained at least until the end of the period of the application of the voltage that allows the brightness values of the pixels to be held by and fixed to the pixels.

Further, during the period in which the horizontal black line 215 is moved, the fixed voltage Vb2 is maintained across the X electrode line immediately above the vertical black line 216. The vertical black line 216 therefore keeps being displayed.

To move the vertical black line 216 and the horizontal black line 215 on X and Y electrode lines simultaneously, the processes of moving the displayed vertical black line 216 and horizontal black line 215 described above may be carried out simultaneously.

FIG. 11 is waveform diagrams depicting a black line moving voltage application sequence for moving the vertical black line 216 between arbitrary adjacent X electrode lines, a first X electrode line and a second X electrode line, and moving the horizontal black line 215 between arbitrary adjacent Y electrode lines, a first Y electrode line and a second Y electrode line, in the cholesteric liquid crystal device 10. In the waveform diagrams depicted in FIG. 11, the horizontal axis represents time, and the vertical axis represents the voltage applied to pixels on an electrode line of interest. Further, in FIG. 11, a first waveform diagram to a six waveform diagram are depicted from above to below.

A description will be made of the operation of moving the vertical black line 216 from the first X electrode line to the second X electrode line and then moving the horizontal black line 215 from the first Y electrode line to the second Y electrode line with reference to the first to six waveform diagrams.

The first waveform diagram depicts the black line moving voltage application sequence performed on the pixels on the first X electrode line. The black line moving voltage application sequence described above includes first and second actions and is performed as follows: the voltage −V1 is applied in accordance with the Y electrode lines before time T1. Suppose that the vertical black line 216 has been moved to the first X electrode line at time T1. The voltage that achieves the transparent state is therefore applied to the pixels on the first X electrode line, which is the first action. Thereafter, in the second action, 0 V is applied to the pixels on the first X electrode line so that the brightness values of the pixels are held by and fixed to the pixels.

After time T2, the vertical black line 216 is not displayed on the first X electrode line, to which the following voltage is applied: In the first action at the time T2, voltages lower than or equal to V0 and according to the brightness values of the pixels on the horizontal black line 215 on the first Y electrode line are applied. In the following second action, 0 V is applied so that the brightness values of the pixels on the horizontal black line 215 are fixed. The actions performed in the period from the time T2 to T3 are repeated in the period from the time T3 to T4 and after the time T4.

The second waveform diagram depicts the black line moving voltage application sequence performed on the pixels on the second X electrode line. The black line moving voltage application sequence described above includes first and second actions and is performed as follows:

A voltage application sequence including the following first and second actions is first performed: That is, in the first action, voltages lower than or equal to V0 and according to the brightness values of the pixels on the Y electrode line that is displaying the black line are applied to the second X electrode line before the time T2. In the second action, 0 V is applied to the second X electrode line before the time T2 so that the brightness values of the pixels thereon are fixed.

Since the vertical black line 216 has been moved to the second X electrode line at the time T2, the black line moving voltage application sequence is performed on the second X electrode line. In the first action, the voltage −V1, which achieves the transparent state, is applied to the pixels on the second X electrode line. Thereafter, in the second action, 0 V is applied to the pixels on the second X electrode line so that the brightness values of the pixels on the second X electrode line are held by and fixed to the pixels.

In the period from the time T2 to T3, the horizontal black line 215 is displayed on the pixels on the first Y electrode line, and the horizontal black line 215 is moved to the pixels on the second Y electrode line.

That is, in the first action, the Y driver 38 applies voltages according to the brightness values of the pixels on the second X electrode line to the Y electrode lines except the first Y electrode line that is displaying the horizontal black line 215. In the period from the time T2 to T3, the Y electrode lines except the first Y electrode line include the second Y electrode line.

The third waveform diagram depicts the black line moving voltage application sequence performed on the pixels on the first Y electrode line.

Voltages lower than or equal to V0 and according to the first Y electrode line are applied to X electrode lines including the first and second X electrode lines before time T2.

Since the horizontal black line 215 has been moved to the first Y electrode line at the time T2, the black line moving voltage application sequence is performed on the first Y electrode line.

The black line moving voltage application sequence includes first and second actions. In the first action, the voltage that achieves the transparent state is applied to the pixels on the first Y electrode line. Thereafter, in the second action, 0 V is applied to the first Y electrode line. Since the voltages lower than or equal to V0 and according to the brightness values of the pixels on the first Y electrode line are applied to the X electrode lines, the brightness values of the pixels are fixed to the pixels. Thereafter, the horizontal black line 215 is moved to the adjacent second Y electrode line at the time T3.

The fourth waveform diagram depicts the black line moving voltage application sequence performed on the pixels on the second Y electrode line.

Voltages lower than or equal to V0 and according to the brightness values of the pixels on the horizontal black line 215 on the second Y electrode line are applied to the X electrode lines including the first and second X electrode lines before time T3.

Since the horizontal black line 215 has been moved to the second Y electrode line at the time T3, the black line moving voltage application sequence is performed on the second Y electrode line.

The black line moving voltage application sequence includes first and second actions. In the first action, the voltage that achieves the transparent state is applied to the pixels on the second Y electrode line. Thereafter, in the second action, 0 V is applied to the second Y electrode line. Since the voltages lower than or equal to V0 and according to the brightness values of the pixels on the second Y electrode line are applied to the X electrode lines, the brightness values of the pixels are fixed to the pixels. Thereafter, the horizontal black line 215 is moved to the adjacent Y electrode line at time T4.

The fifth waveform diagram depicts a voltage according to the pixel at the intersection of the first X electrode line and the second Y electrode line. The sixth waveform diagram depicts a voltage according to the pixel at the intersection of the second X electrode line and the second Y electrode line. When the pixels are displaying the black lines, the voltages applied to the pixels at the intersections in the first action fall within the range from the voltage V1 to V2, and the cholesteric liquid crystal material in the pixels maintains the transparent state during the voltage application period. Thereafter, since 0 V is applied to the pixels at the intersections in the second action, the brightness values of the pixels at the intersections according to the voltages applied in the first action are held by and fixed to the pixels. When the pixels at the intersections are not on the black lines, the voltages applied to the pixels are lower than or equal to V0, and in this case, the pixels are not affected.

As described above, the voltage application sequence for moving the vertical black line 216 and the voltage application sequence for moving the horizontal black line 215 request two actions irrespective of the patterns according to which the vertical black line 216 and the horizontal black line 215 are moved. In the display apparatus 30 according to the second embodiment, the number of collapse of the helical structure in the cholesteric liquid crystal material and the number of charging and discharging in the X and Y electrode lines are equal to those in the first embodiment.

In the display apparatus 30 according to the second embodiment, each of the vertical black line 216 and the horizontal black line 215 is therefore moved in a short period irrespective of the patterns according to which the vertical black line 216 and the horizontal black line 215 are moved. Further, in the display apparatus 30 according to the second embodiment, current consumption in the coordinate extraction mode is also reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A display apparatus comprising:
a display device configured to include a plurality of pixels, each of the pixels being formed of a cholesteric liquid crystal material;
a first electrode and a second electrode that apply a voltage to each of the pixels; and
a drive circuit configured to apply a first voltage, a second voltage, and third voltage between the first and the second electrodes, applying the first voltage causing the cholesteric liquid crystal material to be transparent, applying the second voltage setting reflectance of the cholesteric liquid crystal material in each of the pixels at the time of selection of the each of the pixels, applying the third voltage providing no change in reflectance of the cholesteric liquid crystal material.

2. The display apparatus according to claim 1, wherein:
the plurality of pixels are arranged in matrix,
a plurality of the first electrode are arranged in row direction,
a plurality of the second electrode are arranged in column direction, and
the drive circuit applies the first voltage between two or more of the first electrodes and the second electrodes to select two or more pixels in column direction at same time.

3. The display apparatus according to claim 1, wherein:
the plurality of pixels are arranged in matrix,
a plurality of the first electrode are arranged in row direction,
a plurality of the second electrode are arranged in column direction, and
the drive circuit applies the first voltage between the first electrodes and two or more of the second electrodes to select two or more pixels in row direction at same time.

4. The display apparatus according to claim 1, wherein:
the plurality of pixels are arranged in matrix,
a plurality of the first electrode are arranged in row direction,
a plurality of the second electrode are arranged in column direction,
the drive circuit applies the first voltage between two or more of the first electrodes and two or more of the second electrodes to select two or more pixels in one of row line and two or more pixels in one of column line, and
the drive circuit applies the second voltage between one of the two or more of the first electrodes and one of the two or more of the second electrodes at the one of the plurality pixels that is at an intersection of the one of the row line and the one of the column line.

5. The display apparatus according to claim 1, wherein a voltage range of the third voltage is broader than a voltage range of the second voltage.

6. A controlling method of a display apparatus that includes a display device including a plurality of pixels, each of the pixels being formed of a cholesteric liquid crystal material, the controlling method comprising:
applying a first voltage between the first and the second electrodes, the applying the first voltage causing the cholesteric liquid crystal material to be transparent;
applying a second voltage between the first and the second electrodes, the applying the second voltage setting reflectance of the cholesteric liquid crystal material in each of the pixels at the time of selection of the each of the pixels; and
applying a third voltage between the first and the second electrodes, the applying the third voltage providing no change in reflectance of the cholesteric liquid crystal material.

7. The controlling method according to claim 6, wherein:
the plurality of pixels are arranged in matrix,
a plurality of the first electrode are arranged in row direction,
a plurality of the second electrode are arranged in column direction, and
the applying the first voltage is performed by applying the first voltage between two or more of the first electrodes and the second electrodes to select two or more pixels in column direction at same time.

8. The controlling method according to claim 6, wherein:
the plurality of pixels are arranged in matrix,
a plurality of the first electrode are arranged in row direction,
a plurality of the second electrode are arranged in column direction, and
the applying the first voltage is performed by applying the first voltage between the first electrodes and two or more of the second electrodes to select two or more pixels in row direction at same time.

9. The controlling method according to claim 6, wherein the plurality of pixels are arranged in matrix,
a plurality of the first electrode are arranged in row direction,
a plurality of the second electrode are arranged in column direction,
the applying the first voltage is performed by applying the first voltage between two or more of the first electrodes and two or more of the second electrodes to select two or more pixels in one of row line and two or more pixels in one of column line, and applying the second voltage between one of the two or more of the first electrodes and one of the two or more of the second electrodes at the one of the plurality pixels that is at an intersection of the one of the row line and the one of the column line.

10. The controlling method according to claim 6, wherein a voltage range of the third voltage is broader than a voltage range of the second voltage.
